(19) United States
(12) Patent Application Publication
(10) Pub. No.: US 2013/0167374 A1
(43) Pub. Date: Jul. 4, 2013

(54) PROCESS OF PRODUCING CERAMIC MATRIX COMPOSITES AND CERAMIC MATRIX COMPOSITES FORMED THEREBY

(71) Applicant: General Electric Company, Schenectady, NY (US)

(72) Inventors: Glen Harold Kirby, Liberty Township, OH (US); James Dale Steibel, Mason, OH (US); Nathaniel David Goss, Cincinnati, OH (US)

(73) Assignee: GENERAL ELECTRIC COMPANY, Schenectady, NY (US)

(21) Appl. No.: 13/685,038

(22) Filed: Nov. 26, 2012

Related U.S. Application Data
(60) Provisional application No. 61/581,129, filed on Dec. 29, 2011.

(51) Int. Cl. C04B 35/64; F02C 7/00; B32B 18/00

(52) U.S. Cl. CPC C04B 35/64; B32B 18/00; F02C 7/00
USPC 29/888.02; 156/89.11; 428/317.9

(57) ABSTRACT

A process for producing a silicon-containing CMC article. The process entails depositing one or more coating layers on silicon carbide (SiC) fibers, drawing the coated SiC fibers through a slurry to produce slurry-coated fiber material, and then processing the slurry-coated SiC fiber material to form unidirectional prepreg tapes. The tapes are stacked and then fired to yield a porous preform. The porous preform is then further densified by infiltrating the porosity therein to yield a CMC article. Infiltration can be achieved by a series of polymer infiltration and pyrolysis (PIP) steps, by melt infiltration (MI) after filling the porosity in the preform with carbon or one or more refractory metal, by chemical vapor infiltration (CVI), or by a combination of these infiltration techniques.

### CROSS REFERENCE TO RELATED APPLICATIONS

This application claims the benefit of U.S. Provisional Application No. 61/581,129, filed Dec. 29, 2011, the contents of which are incorporated herein by reference.

### STATEMENT REGARDING FEDERALLY SPONSORED RESEARCH

This invention was made with government support under Contract No. N00421-08-C-0041 awarded by the Navy. The Government has certain rights in the invention.

### BACKGROUND OF THE INVENTION

The present invention generally relates to ceramic matrix composite (CMC) articles and processes for their production. More particularly, this invention is directed to a process of producing silicon-containing CMC articles that includes processing steps capable of yielding CMC articles that exhibit desirable physical, mechanical, and microstructural properties at elevated temperatures.

Higher operating temperatures for gas turbine engines are continuously sought in order to increase their efficiency. Though significant advances in high temperature capabilities have been achieved through formulation of iron, nickel and cobalt-base superalloys, alternative materials have been investigated. CMC materials are a notable example because their high temperature capabilities can significantly reduce cooling air requirements. CMC materials generally comprise a ceramic fiber reinforcement material embedded in a ceramic matrix material. The reinforcement material may be discontinuous short fibers dispersed in the matrix material or continuous fibers or fiber bundles oriented within the matrix material, and serves as the load-bearing constituent of the CMC. In turn, the ceramic matrix protects the reinforcement material, maintains the orientation of its fibers, and serves to dissipate loads to the reinforcement material. Individual fibers (filaments) are often coated with a release agent, such as boron nitride (BN), to form a de-bond layer that allows for limited and controlled slip between the fibers and the ceramic matrix material.

Continuous fiber reinforced ceramic composites (CFCC) are a type of CMC that offers light weight, high strength, and high stiffness for a variety of high temperature load-bearing applications, including shrouds, combustor liners, vanes, blades, and other high-temperature components of gas turbine engines. A CFCC material is generally characterized by continuous fibers (filaments) that may be arranged to form a unidirectional array of fibers, or bundled in tows that are arranged to form a unidirectional array of tows, or bundled in tows that are woven to form a two-dimensional fabric or woven or braided to form a three-dimensional fabric. For three-dimensional fabrics, sets of unidirectional tows may, for example, be interwoven transverse to each other. Of particular interest to high-temperature applications are silicon-based composites, such as silicon carbide (SiC) as the matrix and/or reinforcement material. SiC fibers have also been used as a reinforcement material for a variety of other ceramic matrix materials, including titanium carbide (TiC), silicon nitride (Si₃N₄), and alumina (Al₂O₃).

Examples of CMC materials and particularly SiC/Si—SiC (fiber/matrix) continuous fiber-reinforced ceramic composites (CFCC) materials and processes are disclosed in U.S. Pat. Nos. 5,015,540, 5,330,854, 5,336,350, 5,628,938, 6,024,898, 6,258,737, 6,403,158, and 6,503,441, and U.S. Patent Application Publication No. 2004/0067316, whose contents are incorporated herein by reference. Such processes generally entail the fabrication of CMCs using multiple prepreg layers, each in the form of a “tape” comprising the desired ceramic fiber reinforcement material, one or more precursors of the CMC matrix material, and organic resin binders. According to conventional practice, prepreg tapes can be formed by impregnating the reinforcement material with a slurry that contains the ceramic precursor(s) and binders. Preferred materials for the precursor will depend on the particular composition desired for the ceramic matrix of the CMC component, for example, SiC powder and/or one or more carbon-containing materials that are ultimately converted to SiC upon reaction with molten Si. Other typical slurry ingredients include organic binders that promote the pliability of prepreg tapes, and solvents for the binders that promote the fluidity of the slurry to enable impregnation of the fiber reinforcement material.

After allowing the slurry to partially dry and, if appropriate, partially curing the binders (B-staging), the resulting prepreg tape is laid-up with other tapes, and then debulked and, if appropriate, cured while subjected to elevated pressures and temperatures to produce a preform. The preform is then heated (fired) in a vacuum or inert atmosphere to decompose the binders, remove solvents, and convert the precursor to the desired ceramic matrix material. Due to decomposition of the binders, the result is a porous CMC body that may undergo melt infiltration (MI) to fill the porosity and yield the CMC component. Melt-infiltration processes used to produce SiC matrices generally entail infiltrating the porous CMC body with molten silicon supplied externally. The molten silicon infiltrates into the porosity, reacts with the carbon content of the matrix to form silicon carbide, and fills the porosity to yield the desired CMC component. Specific processing techniques and parameters for the above process will depend on the particular composition of the materials.

An example of a CFCC material 10 is schematically depicted in FIG. 1 as comprising multiple laminae 12, each derived from an individual prepreg tape that comprised unidirectionally-aligned reinforcement material 14 impregnated with a ceramic matrix precursor. As a result, each lamina 12 contains the reinforcement material 14 encased in a ceramic matrix 18 formed, wholly or in part, by conversion of the ceramic matrix precursor during firing and melt infiltration.

CMCs and CFCCs articles produced to contain silicon carbide fibers in a silicon carbide matrix in the manner discussed above contain elemental silicon and/or silicon alloy, and therefore cannot be used at temperatures exceeding the melting point of silicon (about 1405° C.) or any low-melting silicon alloy (for example, about 1360° C.) in the matrix because the molten silicon may react with release agents such as boron nitride on the fibers/tows, causing embrittlement of the composite. Furthermore, molten silicon tends to seep from the surface of the composite article, where it may react with and damage an environmental barrier coating (EBC) protecting the article and potentially any metallic or other ceramic component contacting or in close proximity to the article.

Some approaches to eliminating or at least reducing the content of elemental silicon or low-melting silicon alloys in a CMC article are disclosed in U.S. Published Patent Application No. 2010/0279845 to Kebbede et al., whose contents are incorporated herein by reference. According to Kebbede et al., the removal of free silicon and/or silicon alloy from a CMC article creates internal cavities, and any remaining silicon and/or silicon alloy can be converted to a refractory ceramic material by reaction with reactive gaseous species. Access to the cavities can be obstructed by at least partially filling the cavities and/or plugging the surface access routes to the cavities with a refractory solid. While not intending to promote any particular interpretation, it appears that Kebbede et al. describe melt-infiltration CMC bodies from which the low melting silicon or silicon alloy has been removed so that it cannot react with the fibers or release agents, and provide a method to prevent internal oxidation of the material due to the porosity that is created by the absence of the silicon or silicon alloy. However, it is believed that the absence of the silicon or silicon alloy that serves to distribute stress to any number of individual fibers within a tow bundle also results in a significant debit in mechanical behavior. This debit in mechanical behavior can prevent the CMC from meeting design requirements necessary for turbine engine components even at low temperature.

In view of the above, it can be appreciated that there is a continuing need for CMC articles that exhibit suitable physical, mechanical, and microstructural properties at elevated temperatures, and particularly temperatures exceeding the melting point of silicon.

### BRIEF DESCRIPTION OF THE INVENTION

The present invention provides a process for producing a silicon-containing CMC article that includes processing steps to enable the CMC article to exhibit suitable physical, mechanical, and microstructural properties at elevated temperatures, and particularly temperatures exceeding the melting point of silicon.

According to a first aspect of the invention, a process is provided for producing a silicon-containing CMC article. The process entails depositing one or more coating layers on silicon carbide (SiC) fibers, drawing the coated SiC fibers through a slurry to produce slurry-coated fiber material, and then processing the slurry-coated SiC fiber material to form unidirectional prepreg tapes. The tapes are stacked and then fired to yield a porous preform. The porous preform is then further densified by infiltrating the porosity therein to yield a CMC article.

According to a second aspect of the invention, a CMC article includes a ceramic matrix reinforced with coated silicon carbide fibers. The matrix includes at least 90 vol. % silicon-based refractory compounds, up to 5 vol. % porosity, and up to 5 vol. % of one or more low-melting phases chosen from the group consisting of elemental silicon, silicon alloys, silicon-based compounds, and combinations thereof.

A technical effect of the invention is the ability to produce SiC-based CMC and CFCC articles that are capable of use at temperatures exceeding the melting point of elemental silicon and silicon alloys. While previous methods have sought to eliminate elemental silicon and low-melting silicon alloys from CMC articles to yield a matrix phase formed entirely of refractory silicon-based materials, such methods have yielded matrices that contain porosity and therefore are not fully dense. In contrast, the present invention is directed to producing CMC articles that are not only essentially free of elemental silicon and low-melting silicon alloys, but also contain a dense matrix that is essentially free of porosity, for example, contains less than 5 vol. % porosity.

Other aspects and advantages of this invention will be better appreciated from the following detailed description.

### BRIEF DESCRIPTION OF THE DRAWINGS

FIG. 1 schematically represents a fragmentary cross-sectional view of a CFCC article.

FIG. 2 is a scanned image of a CFCC article produced by a process within the scope of the invention.

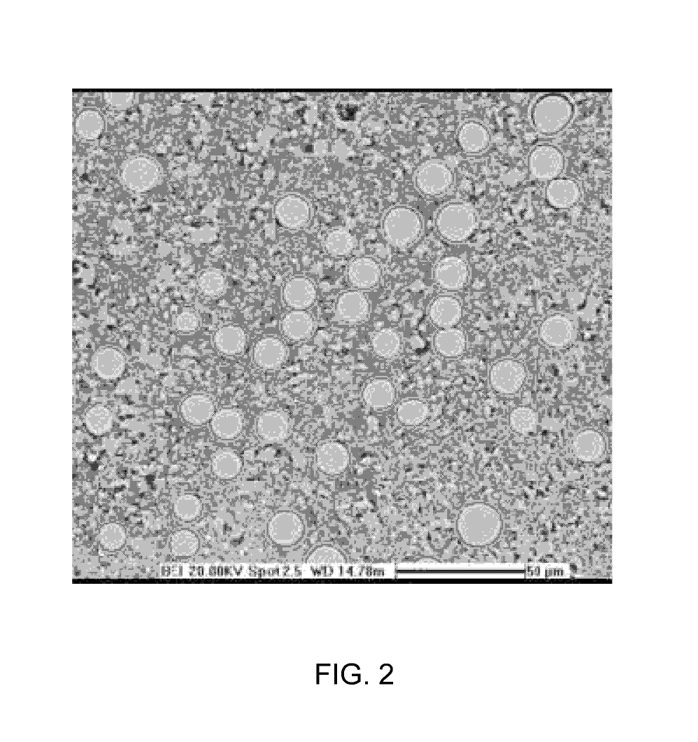

### DETAILED DESCRIPTION OF THE INVENTION

The present invention will be described in terms of processes for producing CMC articles, including CFCC articles, that can be used at temperatures exceeding the melting point of low-melting silicon alloys (for example, about 1357° C.), and preferably up to temperatures of at least 1480° C., and therefore well over the melting point of silicon and low-melting alloys thereof. CMC materials of particular interest to the invention are those containing silicon, such as CMC's containing silicon carbide as the reinforcement and/or matrix material, a particular example of which is continuous silicon carbide fibers in a matrix of silicon carbide. However, other silicon-containing materials are also within the scope of the invention, including ceramics such as silicon nitride and silicides (intermetallics) such as niobium silicide and molybdenum silicide. While various applications are foreseeable, particular applications for the component 10 include components of gas turbine engines, such as combustor liners, blades, vanes and shrouds within the turbine sections of gas turbines.

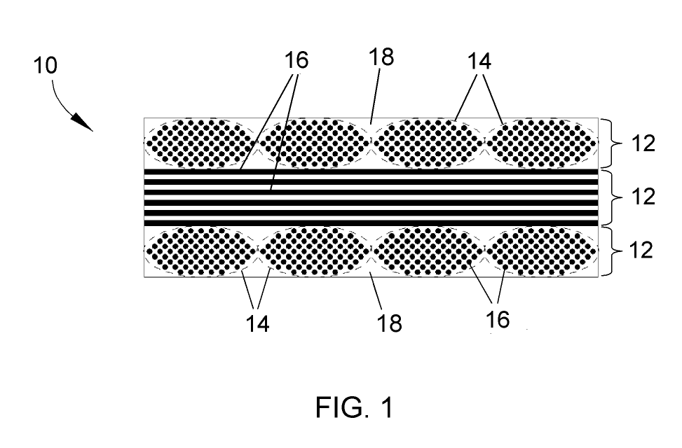

The following discussion of CMC articles of this invention will make reference to FIG. 1, which as noted previously is representative of a CFCC component 10 comprising multiple laminae 12, each derived from an individual prepreg that originally comprised unidirectionally-aligned tows 14 impregnated with a ceramic matrix precursor. As a result of debulking, curing and firing the laminate preform formed by the stacked prepregs, each lamina 12 contains unidirectionally-aligned fibers 16 encased in a matrix 18 that includes a silicon carbide phase that may be formed in part by conversion of the ceramic matrix precursor during firing and melt infiltration. However, as a particular aspect of the present invention, with further processing steps as described below the matrix 18 preferably does not contain an elemental silicon or silicon alloy phase as previously ascribed to CMCs produced by silicon melt infiltration processes. Instead, the matrix 18 is preferably either entirely formed of one or more ceramic materials.

As a CFCC component 10, the tows 14 are preferably unidirectional in each lamina 12, i.e., oriented side-by-side and parallel to each other. Suitable fiber diameters, tow diameters and center-to-center tow spacings will depend on the particular application, the thicknesses of the laminae 12, and other factors, and therefore are not represented to scale in FIG. 1. According to known practice, the individual fibers 16 of the tows 14 are preferably coated with one or more release agents to form a de-bond fiber coating (not shown) that allows for limited and controlled slip between the matrix 18 and the tows 14 and their individual fibers 16. Suitable materials for the fiber coating include boron nitride (BN), silicon-doped BN, silicon nitride (Si₃N₄), silicon carbide (SiC), hafnium carbide (HfC), hafnium nitride (HfN), zirconium carbide (ZrC), zirconium nitride (ZrN), tantalum carbide (TaC), tantalum nitride (TaN), and mixtures thereof. A preferred fiber coating comprises multiple layers of one or more of these compounds. As cracks develop in the component 10, fibers 16 that bridge the crack act to redistribute the load to adjacent fibers 16 and regions of the matrix 18, thus inhibiting or at least slowing further propagation of the crack.

As previously noted, during the fabrication of the component 10 a desired number of prepreg tapes are laid-up to form a preform that undergoes further processing to yield the component 10. Each tape is formed to contain a reinforcement architecture (formed by the fibers 16) encased within a precursor of the desired material for the matrix 18, e.g., SiC. One of ordinary skill in the art will recognize that an important aspect of the invention is the use of unidirectional fiber prepreg tapes to build up the composite structure. CMC architectures derived from unidirectional prepreg offer improved mechanical properties at elevated temperatures above the melting point of silicon. It is believed that because each fiber is well-isolated via the refractory matrix phase, mechanical loads can be transferred more efficiently to each individual fiber, which in turn promotes improved mechanical properties. According to conventional practice, such prepreg tapes can be formed in a single operation, for example, by applying a precursor-containing slurry during winding of a continuous strand of tow 16 onto a drum. Following the winding operation, the slurry is allowed to partially dry and the resulting prepreg tape is removed from the drum, laid-up with other tapes, and then debulked and cured (if appropriate) while subjected to elevated pressures and temperatures to form a cured preform. The preform is then heated in vacuum or in an inert atmosphere to decompose the organic binders and yield a porous rigid preform.

The following processing techniques are intended to greatly improve the temperature capability of a CMC article produced by processing steps of the type described above by reducing or entirely eliminating porosity within the CMC article, as well as reducing or entirely eliminating any residual elemental silicon and/or low-melting silicon alloys in the CMC article.

According to a preferred aspect of the invention, reduced porosity content can be accomplished through a densification process that comprises one or more infiltration steps. For example, a series of polymer infiltration and pyrolysis (PIP) steps can be used to fill porosity and simultaneously eliminate the possibility of having any residual silicon or low-melting silicon alloy. Such a PIP process utilizes a polymeric precursor that when pyrolyzed (preferably in an inert atmosphere, for example, a vacuum or argon) forms a desired ceramic by itself. Examples of desirable ceramics include silicon carbide, silicon nitride, silicon oxycarbide, silicon oxynitride, silicon carbonitride, silicon oxycarbonitride, or mixtures thereof. These compounds have high melting points (above 1480° C.) compared to silicon and its low-melting alloys.

Additional or alternative infiltration techniques that may be used include chemical vapor infiltration (CVI) and melt infiltration (MI). As previously practiced in the art, the MI process has been used in cases where the preform was formed with a slurry that, upon firing, results in a carbon-containing preform that preferably reacts with molten silicon to form silicon carbide. In the present invention, carbon additions can also be achieved by subjecting the porous preform to direct infiltration of carbon black particles or burnout of a carbon-yielding resin that had been infiltrated into the pore space. In another approach, the pore space could be filled with a refractory metal or a refractory metal-containing compound that forms a refractory silicide phase upon reaction with molten silicon.

The densification processes noted above can benefit from the use of certain prepreg slurries that preferably do not leave residual elemental silicon or silicon alloys in the porous preform, and preferably yield a continuous network of silicon carbide or carbon to provide strength within the porous preform prior to infiltration. Various precursor-containing slurries have been applied to continuous fibers and tows to produce prepreg tapes. Typical slurry compositions have contained, in addition to the desired ceramic precursor(s), ceramic constituents of the matrix (for example, silicon carbide), organic resins that serve as processing aids (for example, polyvinybutyral and poly isobutyl methacrylate), solvents (for example, toluene, MIBK, ethylbenzene, etc.), and plasticizers for the binders (for example, dibutyl phthalate). Slurry compositions for use in the present invention may contain an approximately 1:1 stoichiometric mixture of elemental silicon and carbon black that react during firing of the preform at temperatures of about 1430° C. to about 1460° C. The slurry composition may additionally contain one or more organic binders that can be pyrolyzed to form a network of carbon char (for example, furanic resins and/or phenolic resins). In any case, the result is preferably a cured and rigid preform that can be essentially free of elemental silicon and silicon alloys, and in which the fibers are encased in a porous yet continuous network of silicon carbide filaments or carbon char (depending on the particulars of the embodiment as described above). This porosity can then be eliminated by the densification processes discussed above, such that the network of silicon carbide filaments or carbon char provides a scaffold for reinforcement to prevent cracking due to the stresses involved in pyrolysis of the polymeric precursor, particular during the first densification cycle.

Additional processing steps can be performed to extract any residual elemental silicon and/or low-melting silicon alloy phase within the CMC article. An extraction step is particularly desirable if a slurry is used that contains an excess of elemental silicon relative to what is needed for a 1:1 stoichiometric mixture of elemental silicon and carbon black, or if a slurry is used that does not contain any elemental silicon and a melt infiltration step is performed using an external source of elemental silicon or a silicon alloy as the infiltrant. For the latter, typical slurry compositions have contained silicon carbide, carbon black, organic resins that serve as processing aids (for example, polyvinybutyral), organic resins that are pyrolyzed to form a network of carbon char, solvents (for example, toluene, MIBK, alcohols, and acetone), etc.), and plasticizers for the binders (for example, dibutyl phthalate). Coated silicon carbide fibers may be drawn through this slurry and wound upon a drum to form prepreg tapes. The tapes are laid-up in the desired orientation and consolidated under heat and pressure to form a laminate. The laminate is heated in nitrogen, argon, or vacuum to burn out a portion of the organic binders and resins, while also converting a portion of the binders and resins to carbon char. The burned-out porous laminate can then be melt infiltrated by heating an external source of silicon or silicon alloy such that it melts and flows into the laminate. A first portion of this molten silicon or silicon alloy reacts with the precursor carbon in the porous laminate to form silicon carbide, and a second portion of the molten silicon or silicon alloy fills the porosity in the laminate. Upon cooling, the silicon or silicon alloy filling the pore space solidifies. This silicon or silicon alloy is the desired phase to extract from the melt-infiltrated CMC to form a porous preform.

In the case where a prepreg slurry is used that does not contain silicon and a melt infiltration is carried out where an external source of silicon or silicon alloy is used as the infiltrant, the slurry can optionally contain refractory metals or compounds in addition to silicon carbide and carbon black. The refractory metal reacts with residual elemental silicon and/or low-melting silicon alloy to form refractory silicides and serves to reduce the overall residual silicon or silicon alloy content in the MI CMC that would need to be extracted. Suitable refractory metals and compounds include molybdenum, molybdenum silicide (Mo₅Si₃), molybdenum carbide, molybdenum nitride, tantalum, tantalum carbide, tantalum silicide, tantalum nitride, niobium, niobium carbide, niobium silicide, niobium nitride, or combinations thereof. Optionally, these materials can be incorporated into the external source of silicon or silicon alloy so that a refractory silicide forms once the silicon content in the melt is sufficiently depleted by reaction with carbon black. This approach would ensure that refractory silicides precipitate within the residual silicon upon cooling, thereby reducing the volume of low melting silicon or silicon alloy that would need to be extracted.

A suitable extraction technique is a powder pack extraction process that involves surrounding the CMC article with a porous material and heating until the silicon or silicon alloy is molten. Porous materials may include, but are not limited to, carbon black, graphite, industrial diamond, silicon carbide, silicon nitride, molybdenum and its silicides, carbides and nitrides, tungsten and its silicides, carbides and nitrides, tantalum and its silicides, carbides and nitrides, and/or niobium and its silicides, carbides and nitrides. Preferred porous materials include those that provide a chemical driving force to draw out the silicon or silicon alloy, do not react strongly with the silicon carbide in the melt-infiltrated body and, in case there is a shallow reaction layer, are easily removed by grinding or grit blasting to ensure that the pore network left behind is open for subsequent infiltration. Preferred porous materials include molybdenum, tungsten, tantalum, niobium metal, and niobium silicides. These materials are capable of adequately extracting residual silicon and silicon alloy and forming metal silicides on the surface of the CMC article that are easily removed by grit blasting to expose pore channels within the CMC article. Once exposed, the pore channels can be filled with one or more precursors that can be converted to silicon carbide by a PIP, MI, or CVI technique.

Another suitable extraction technique is a liquid phase extraction process carried out by exposing the CMC article to a liquid that is corrosive to residual silicon alloy, but not to any other components of the CMC article. Examples of such liquids are hydrofluoric acid (HF), mixtures of hydrofluoric acid and other acids, strongly basic solutions such as aqueous NaOH, LiOH, KOH, etc., liquid metals such as gallium, indium, tin, and mercury, and multistage leaching processes that involve liquid metals, acids, and bases. The liquid phases can be heated to increase the rate at which they dissolve the residual silicon alloy. This is particularly true for liquid metals, which require an elevated temperature to activate the silicon alloy removal process. Heat treatments may be performed to eliminate any contaminants, for example, to evaporate fluorine or any metal in the pore channels. As before, the exposed pore channels can be filled with one or more precursors that can be converted to silicon carbide by a PIP, MI, or CVI technique.

Another suitable extraction technique is vaporization of silicon or silicon alloy at high temperature in a strong vacuum. As before, the exposed pore channels can be filled with one or more precursors that can be converted to silicon carbide by a PIP, MI, or CVI technique.

Once densification of a CMC article is complete, the resulting CMC article preferably comprises at least 90 vol. % silicon-based refractory compounds, which may include one or more of silicon compounded with elements such as carbon, nitrogen, oxygen, molybdenum, tantalum, niobium, and mixtures thereof. The matrix may also contain up to 5 vol. % porosity and up to 5 vol. % low-melting phases (phases that melt below 1480° C.), such as pure elemental silicon, low-melting silicon alloys (e.g., silicon-boron alloy), low-melting silicon-based compounds (e.g., iron silicide), and/or combinations thereof. More preferably, the CMC articles have a matrix that contains less than 5% of the sum of low-melting phases and porosity. The most preferred CMC articles have a matrix that contains less than 5 vol. % porosity and is essentially free of low-melting phases.

An example of a dense microstructure that can be achieved with the present invention is shown in FIG. 4. The microstructure is essentially free of silicon and silicon alloy phase, with the result that the microstructure is capable of structurally and chemically withstanding temperatures above the melting point of silicon and its low-melting alloys. For example, the microstructure is suitable for CMC components such as combustor liners, blades, vanes and shrouds, which can be installed in a gas turbine engine and subjected to temperatures of up to above 1480° C. and possibly higher.

While the invention has been described in terms of preferred embodiments, it is apparent that other forms could be adopted by one skilled in the art. For example, the parameters and materials used in the above noted processes could differ from that described, and additional materials and processes other than those noted could be included. Therefore, the scope of the invention is to be limited only by the following claims.

1. A process for producing a silicon-containing CMC article, the process comprising:
depositing one or more coating layers on silicon carbide fibers;
drawing the coated silicon carbide fibers through a slurry to produce slurry-coated fiber material;
producing unidirectional prepreg tapes from the slurry-coated fiber material;
stacking the tapes to form a preform;
firing the preform to yield a porous fired preform; and then
densifying the porous fired preform by infiltrating porosity therein to yield a CMC article.

2. The process of claim 1, wherein the composition of the slurry comprises an approximately 1:1 stoichiometric mixture of elemental silicon and carbon black that react during firing of the preform at temperatures of about 1430° C. to about 1460° C.

3. The process of claim 1, wherein the composition of the slurry comprises one or more organic binders that are pyrolyzed during the firing step to form a network of carbon char.

4. The process of claim 1, wherein the composition of the slurry comprises one or more refractory materials.

5. The process of claim 4, wherein the composition of the refractory materials is chosen from the group consisting of molybdenum, molybdenum silicide (Mo₅Si₃), molybdenum carbide, molybdenum nitride, tantalum, tantalum carbide, tantalum silicide, tantalum nitride, niobium, niobium carbide, niobium silicide, niobium nitride, and combinations thereof.

6. The process of claim 1, further comprising extracting residual elemental silicon and/or low-melting silicon alloy phase within the porous fired preform prior to the densifying step.

7. The process of claim 6, wherein the residual elemental silicon and/or low-melting silicon alloy phase is extracted using a powder pack extraction process.

8. The process of claim 7, wherein the powder pack extraction process is performed with a porous material chosen from the group consisting of molybdenum, tungsten, tantalum, niobium metal, and niobium silicides.

9. The process of claim 6, wherein the residual elemental silicon and/or low-melting silicon alloy phase is extracted using a liquid phase extraction process.

10. The process of claim 6, wherein the residual elemental silicon and/or low-melting silicon alloy phase is extracted using a vaporization process.

11. The process of claim 6, further comprising densifying the porous fired preform by infiltrating the porous fired preform using a series of polymer infiltration and pyrolysis steps, melt infiltration with elemental silicon and/or one or more silicon alloys, chemical vapor infiltration, or a combination thereof.

12. The process of claim 1, further comprising heat treating the porous fired preform to remove contaminants in pore channels of the porous fired preform prior to the densifying step.

13. The process of claim 1, wherein the densifying step comprises infiltrating the porous fired preform using a series of polymer infiltration and pyrolysis steps, melt infiltration with elemental silicon and/or one or more silicon alloys, chemical vapor infiltration, or a combination thereof.

14. The process of claim 13, wherein the densifying step comprises a series of polymer infiltration and pyrolysis steps comprising a polymeric precursor that when pyrolyzed forms a ceramic chosen from the group consisting of silicon carbide, silicon nitride, silicon oxycarbide, silicon oxynitride, silicon carbonitride, silicon oxycarbonitride, and combinations thereof.

15. The process of claim 1, further comprising installing the CMC article in a gas turbine engine and subjecting the CMC article to a temperature of at least about 1480° C.

16. The CMC article formed by the process of claim 1.

17. A CMC article comprising a ceramic matrix reinforced with coated silicon carbide fibers, the matrix comprising at least 90 vol. % silicon-based refractory compounds, up to 5 vol. % porosity, and up to 5 vol. % of one or more low-melting phases chosen from the group consisting of elemental silicon, silicon alloys, silicon-based compounds, and combinations thereof.

18. The CMC article of claim 17, wherein the silicon-based refractory compounds are chosen from the group consisting of silicon compounded with carbon, nitrogen, oxygen, molybdenum, tungsten, tantalum, niobium, and mixtures thereof.

19. The CMC article of claim 17, wherein the matrix contains less than 5 vol. % of the sum of low-melting phases and porosity.

20. The CMC article of claim 17, wherein the matrix contains less than 5 vol. % porosity and is essentially free of low-melting phases.

21. The CMC article of claim 17, wherein the CMC article is a component of a gas turbine engine.
